(19) United States
(12) Patent Application Publication
(10) Pub. No.: US 2010/0185693 A1
(43) Pub. Date: Jul. 22, 2010

(54) METHODS AND APPARATUS FOR CREATING AN AUDIT TRAIL

(76) Inventors: Venkataesh V. Murty, Allen, TX (US); Kartik Srinivasan, Karnataka (IN); Jatin Malik, Karantaka (IN)

Correspondence Address: Pepper Hamilton LLP, 400 Berywn Park, 899 Cassatt Road, Berwyn, PA, 19312-1183, US

(21) Appl. No.: 12/356,487

(22) Filed: Jan. 20, 2009

(51) Int. Cl. G06F 17/30

(52) U.S. Cl. 707/803; 707/E17.044; 707/E17.055

(57) ABSTRACT

Extensible data management system and methods for enabling participants (providers and customers) in a software-as-a-service (SaaS) environment to define audit configurations for generating an audit trail tailored to a customers' business needs. A participant in the SaaS environment may define an extension to the data management system, wherein the extension is associated with a node representing the participant in a hierarchical data structure. The position of the participants in the hierarchical data structure ensures audit configurations created by one customer do not affect the functionality of other customers in the SaaS environment.

### TECHNICAL FIELD

The present invention relates generally to data management, and more specifically to an object-relational system for creating an audit trail.

### BACKGROUND

An enterprise information system provides a technology platform that enables organizations to integrate and coordinate their business practices. At their core, such systems primarily consist of two fundamental components: data, and the business logic which is used to interact with and manage the data. Modern enterprise computing invariably utilizes relational databases to store the data and to provide a stable, clear, and robust implementation of the business logic using a declarative query language, such as structured query language (SQL). SQL is a set-based, declarative query language in which SQL queries specify the rows or columns of one or more tables in the relational database to retrieve data from. Although SQL may provide an effective interface for retrieving and managing data when an implementation of simple business logic is required, the use of SQL becomes considerably more cumbersome as the complexity of the business logic increases.

Modern object-oriented programming languages such as Java and Javascript have been developed to provide an environment for implementing complex business logic. Unlike SQL, object-oriented programming focuses on data rather than processes (although many object-oriented languages also include some procedural elements), with programs composed of self-sufficient modules (i.e., objects) containing all of the information needed within its own data structure for manipulation of the data.

Since relational databases do not store objects directly, there is a general need to bridge the two environments. One of the most common solutions to this problem is the use of Object Relational Mapping (ORM) tools, which allow data to be persisted in a relational data model, while business logic is encoded using objects. That is, ORM tools provide for the creation of an object-relational system, which enables an application written in an object-oriented language to manipulate data in the database in terms of objects, rather than in terms of database-specific concepts such as rows, columns and tables.

### SUMMARY

One embodiment of the invention is directed to a method of enabling at least one first customer in a software-as-a-service (SaaS) environment to create an audit trail. The method comprises acts of: (A) associating the at least one first customer with a first node of a hierarchical data structure; (B) enabling the at least one first customer to define an audit configuration at the first node; and (C) creating the audit trail based at least in part on the audit configuration.

Another embodiment of the invention is directed to a computer system for providing at least one data management service to a plurality of customers in a software-as-a-service (SaaS) environment. The computer system comprises at least one storage device and a processor programmed to store on the at least one storage device, a hierarchical data structure comprising a primary node and a plurality of secondary nodes, wherein the primary node is associated with a provider of the SaaS environment and each of the plurality of secondary nodes is associated with at least one of the plurality of customers, wherein the hierarchical data structure insulates a first customer of the plurality of customers from a change made to the computer system by a second customer of the plurality of customers.

Another embodiment is directed to a method of defining an audit configuration for a customer in a software-as-a-service (SaaS) environment. The method comprises acts of: (A) determining at least one parameter for the configuration, the at least one parameter including at least one attribute of a business object and (B) associating the at least one attribute with a message template, wherein the message template comprises at least one placeholder.

Another embodiment is directed to at least one computer-readable medium encoded with a series of instructions that when executed on a computer in a software-as-a-service (SaaS) environment comprising a service provider and at least one customer, perform a method comprising acts of: (A) associating the at least one first customer with a first node of a hierarchical data structure; (B) enabling the at least one first customer to define an audit configuration at the first node; and (C) creating the audit trail based at least in part on the audit configuration.

Another embodiment is directed to a method of maintaining isolation between a first customer and a second customer in a software-as-a-service (SaaS) environment. The method comprises acts of: (A) associating the first customer with a first node in a hierarchical data structure comprising a primary node and a plurality of secondary nodes coupled to the primary node to form a tree-like structure; and (B) associating the second customer with a second node in the hierarchical data structure, wherein the second node is not in a path connecting the first node and the primary node.

It should be appreciated that all combinations of the foregoing concepts and additional concepts discussed in greater detail below (provided that such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The accompanying drawings are not intended to be drawn to scale. In the drawings, each identical or nearly identical component that is illustrated in various figures is represented by a like reference character. For purposes of clarity, not every component may be labeled in every drawing. In the drawings:

FIG. 1 is an example of a relational table for use with some embodiments of the invention;

FIG. 2 is an example of a Plain Old Java Object (POJO) for use with some embodiments of the invention;

FIGS. 3A, 3B, and 3C are examples of relational tables with a foreign key for use with some embodiments of the invention;

FIGS. 4A and 4B are examples of relational tables for representing a list of nicknames in accordance with some embodiments of the invention;

FIG. 5 is a pictorial representation of an organization tree in accordance with some embodiments of the invention;

FIG. 6 is an example of a relational table for representing an organization in accordance with some embodiments of the invention;

FIG. 7 is an example of a relational table for representing a hierarchical relationship between nodes in the organization tree of FIG. 5 in accordance with some embodiments of the invention;

FIG. 8 is a flow chart for a process for creating an extension attribute in accordance with some embodiments of the invention;

FIG. 9 is an example of a relational table for representing extension attributes in accordance with some embodiments of the invention;

FIGS. 10A, 10B, and 10C are examples of relational tables for configuring audit information in accordance with some embodiments of the invention;

FIG. 11 is a flow chart of a process for configuring an audit trail in accordance with some embodiments of the invention;

FIG. 12 is a flow chart of a process for generating an audit trail in accordance with some embodiments of the invention;

FIGS. 13A, 13B, and 13C are examples of relational tables representing an audit trail generated by some embodiments of the invention;

FIGS. 14A and 14B are examples of relational tables for representing details from a business event in multiple languages, in accordance with some embodiments of the invention;

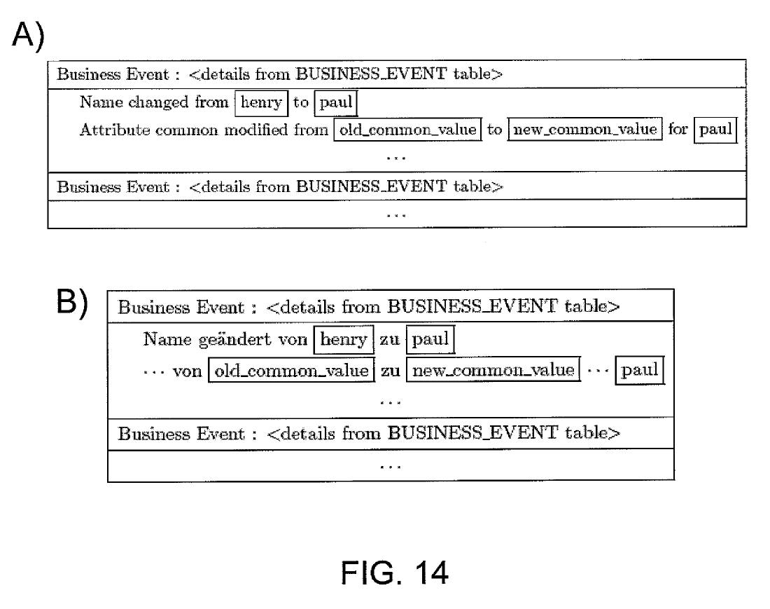

FIG. 15A, 15B, and 15C are examples of output tables generated by an audit trail search process in accordance with some embodiments of the invention; and

FIG. 16 is an example of a computer system on which some embodiments of the invention may be implemented.

### DETAILED DESCRIPTION

### 1. Software-as-a-Service (SaaS)

In a “Software as a Service” (SaaS) model, a SaaS provider uses an enterprise server to provide a service to multiple customers, where each customer may be considered a separate enterprise. The value proposition of a SaaS provider to a customer (e.g., an organization) is two fold. First, a SaaS provider enables an organization to concentrate on its core offerings by outsourcing the activities that are not part of its core competency. Second, a SaaS provider is able to provide an organization with a better quality of service than could be obtained internally at the organization, because the SaaS provider, with the service as it's sole focus, is able to devote significant resources to innovating and improving the service.

Some organizations may be hesitant to outsource services if this decision introduces inefficiencies in their data management system. For example, requesting changes to a data management model in a SaaS system may be time consuming and/or inefficient, especially if the request is unique to a particular customer. In a conventional SaaS system, an organization may request a change to the data management model by providing a representative of the SaaS provider with information about the type of change(s) they would like to implement. Then, the representative may provide this information to a programmer to implement the requested change(s) in the enterprise system, and instruct the customer when the changes have been implemented. Applicants have recognized that the process of implementing changes in a data management model may be streamlined by empowering customers to make changes to the data management model directly. Accordingly, some embodiments of the invention are directed to enabling a customer of an SaaS environment to customize portions of a data management model implemented on an enterprise system of the SaaS provider to meet the specific needs of the customer, while ensuring that changes made by one customer do not affect the functionality or performance of another customer of the SaaS system.

### 2. Object-Relational Systems

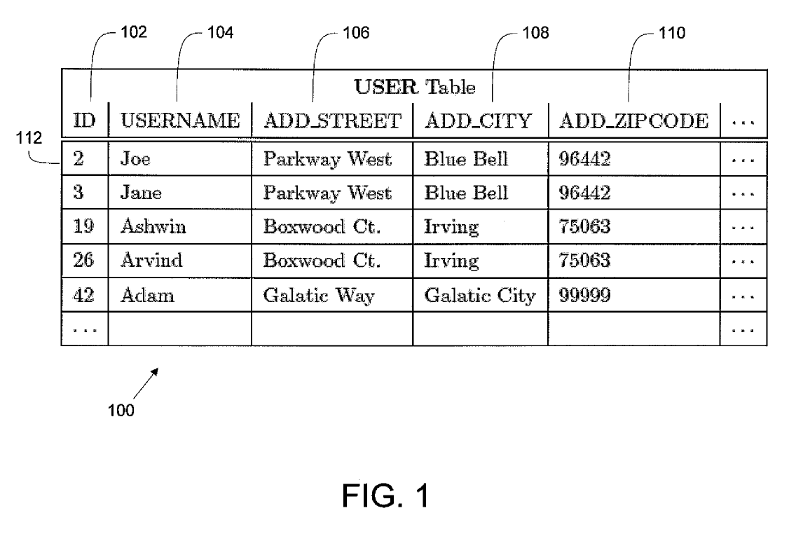

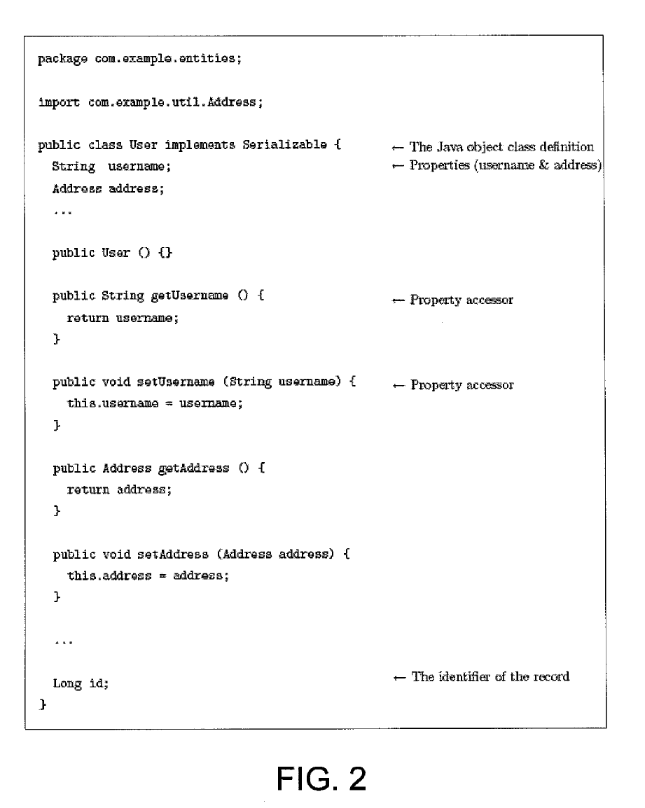

In a standard data model for an enterprise system, an entity refers to a data structure that is used to model a concept. In general, entities (e.g., user, bill of materials, etc.) modeled in a relational system are implemented using one or more tables, where each row in a table refers to an instance of the entity. For example, each record (i.e., row) of the table 100 named “USER,” illustrated in FIG. 1, may represent a user within an organization (e.g., record 112 may represent a user named “Joe”). By contrast, entities modeled in an object-oriented system are implemented using one or more classes, where each instance of a class (called an object) refers to an instance of the entity. Thus, an equivalent representation of the concept “user” in an object/class-oriented environment (e.g., Java) may be represented by the class “com.example.entities.User,” as shown in FIG. 2. In Java parlance, classes that represent entities are commonly referred to as “Plain Old Java Objects” (POJOs).

Objects comprise properties or “attributes” (e.g., id=2, username=Joe, etc.) which associate particular data with the object. In a object-relational system, an ORM tool is responsible for mapping between fields (i.e., columns) in a table row of a relational database and one or more attributes of the corresponding object. One example of a mapping between the attributes in an object model and fields (columns) in a table row of a relational model may be illustrated as follows:

| Object model | | Relational Model |
|---|---|---|
| id | <-> | ID |
| usemame | <-> | USERNAME |
| address | <-> | ADD_STREET, ADD_CITY, |
| | | and ADD_ZIPCODE |

In some embodiments of the invention, the mapping between a relational model representation and an object model representation may be specified using an Extensible Markup Language (XML) file (e.g., named “User.hbm.xml”). For simplicity, embodiments of the invention disclosed herein are described with reference to an OpenSource ORM tool called “Hibernate” (http://www.hibernate.org). However, it should be readily appreciated that any ORM tool may be used with embodiments of the invention, as embodiments of the invention are not limited in this respect.

An ORM tool enables the establishment of an object-relational system in which data is stored in one or more relational databases, while the business logic used to manage and manipulate the data may be implemented in an application written in an object-oriented language. Object-relational systems, in accordance with some embodiments of the invention, generally comprise three elements; a relational part, an object part, and a mapping between the relational part and the mapping part. ORM tools typically provide one or more application programming interfaces (APIs) to enable an application to perform one or more operations on the data in an associated relational database. For example, the ORM tool, Hibernate, includes an API named “org.hibernate.Session” which presents an interface to an application for creating, reading, updating, and deleting data stored in an associated relational database.

In accordance with some embodiments of the invention, a new instance of an object entity (e.g., an entity named “user”) may be created and persisted into a relational table using an API (e.g., “org.hibernate.Session”) as described by the following computer code snippet:

| | |
|---|---|
| User u = new User ( ); | // Creating a new User object |
| ... | |
| session.save (u); | // Propagating changes to relational database |

The above code snippet creates a new record (i.e., row) in the USER table 100. Upon creation of the new record in the table 100, the values in some of the columns may be automatically generated. For example, the column ID (column 102 of the USER table 100) may be automatically generated based on a identifier generation policy for the relational database which includes the USER table.

The API “org.hibernate.Session” (or other suitable API) may also provide an interface to enable an application to read an object (e.g., to load the user “Joe” into memory). The following code snippet loads an object corresponding to the user “Joe” into memory, allows a user to modify Joe's zipcode, and persists this modification to the associated relational database.

| | |
|---|---|
| User u = session.load (User.class, 2); | // Joe's ID in the USER table |
| | is “2” |
| u.getAddress ( ).setZipcode(″94662″); | // Update Joe's address for |
| | the object |

session.update (u); // Propagate changes to relational database

An example of deleting an object (e.g, to remove the user named “Joe” from the relational database) using an API (e.g., “org.hibernate.Session”) is provided below:

session.delete (User.class, 2); //Delete “Joe” from object-relational system.

As should be appreciated from the foregoing examples for manipulating data in an object-relational system, each of the attributes of an object maps to one or more columns in an associated relational database. Some attributes (called “simple attributes”) map to a single column in a table (e.g., the attribute “username” maps to the column 104 (named “USERNAME”) in the USER table 100). For simple attributes, the object type and the database type necessarily match (e.g., in Java, an object with the type “string” (e.g., java.lang.String) maps to a column with the type “VARCHAR” in the relational database).

As described above an object-relational mapping may be stored in an xml file that is accessible by the ORM tool. For example, the xml snippet:

<property name=“username” column=“USERNAME” type=“string” />

creates a mapping between the column 104 in the USER table 100 of a relational database and the object attribute “username.” The xml snippet also indicates that both the object attribute and the data in the column 104 have the same data type (e.g., string).

In contrast to fundamental data types (e.g., string) which represent a single attribute, composite data types may represent multiple attributes and may be implemented in an object environment as a class. As illustrated in the example provided above, the class “address” is a collection of three attributes of fundamental types (i.e., each attribute has the fundamental type string). Unlike the attributes of fundamental types which have a one-to-one mapping to columns in a table of a relational database, attributes of composite types are mapped to multiple columns in a table of a relational database. The following xml snippet illustrates a mapping between the three attributes (street, city, and zipcode) in the composite type “address” and the columns 106, 108, and 110 (e.g., named “STREET,” “CITY,” and “ZIPCODE”) in the USER table 100.

<component name=“address” class=“com.example.util.Address”>
<property name=“street” type=“string” column=“ADD_STREET” />
<property name=“city” type=“string” column=“ADD_CITY” />
<property name=“zipcode” type=“string” column=“ADD_ZIPCODE” />
</component>

In an object-relational system, some types (or classes) may be associated with a table in a relational database, whereas other types (or classes) may not be associated with a table in the relational database. For example, the type “com.example.entities.User” may be considered a first-class business object because it has an associated table named “USER” in the relational database. In contrast, other types (e.g., “java.lang.String” and “com.example.util.Address”) may be considered second-class business objects because they do not have an associated table in the relational database. The inclusion of some second-class business objects enables two users (e.g., named “Joe” and “Jane”) having the same address to refer to two different instances of the same type (e.g., “com.example.util.Address”), and thus, modifying the zipcode for Joe will not change the zipcode for Jane.

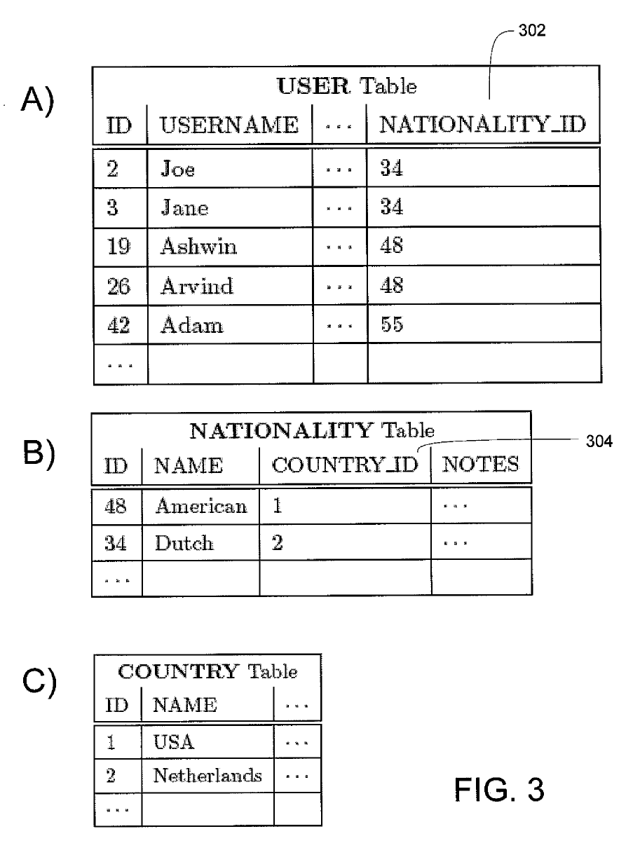

In contrast, under some circumstances, multiple records (e.g., users) in a table may refer to the same instance of a type. As shown in FIG. 3, the user named “Joe and the user named “Jane” both refer to the same instance of the type “Nationality” (i.e., both Joe and Jane have a nationality ID of 34). In this example, the USER table may store a reference to an entity object (e.g., named “com.example.entities.Nationality”) rather than storing an actual data value. Storing a reference to an entity object rather than a data value corresponds to the implementation of a “foreign key” in a relational database. One example of implementing a mapping for a foreign key according to the example shown in FIG. 3 is illustrated by the following xml snippet:

<many-to-one name =“nationality”
column=“NATIONALITY_ID”
class =“com.example.entities.Nationality”/>

In this example, a mapping between the column 302 (named “NATIONALITY_ID”) and the object attribute “nationality” is created. Thus, when the attribute “nationality” is accessed (e.g., via the “org.hibernate.Session,” as discussed above), the corresponding entity object of the type “com.example.entities.Nationality” is returned rather than the ID (i.e., 34) for the object. That is, if an application issued a request for the nationality of the user “Joe” in the USER table of FIG. 3, the mapping above would return a value of “Dutch” from the NATIONALITY table shown in FIG. 3B (i.e., an ID value of 34 is mapped to the name “Dutch”) rather than the ID value “34” from column 302 of the USER table in FIG. 3A.

In a further example, each of the records in the NATIONALITY table of FIG. 3B may additionally be mapped to a third table (e.g., named “COUNTRY”) in the relational database via the column 304 (e.g., named “COUNTRY_ID”) in the NATIONALITY table shown in FIG. 3C. It should be appreciated that tables in a relational database may refer to any number of other tables, as aspects of the invention are not limited in this respect.

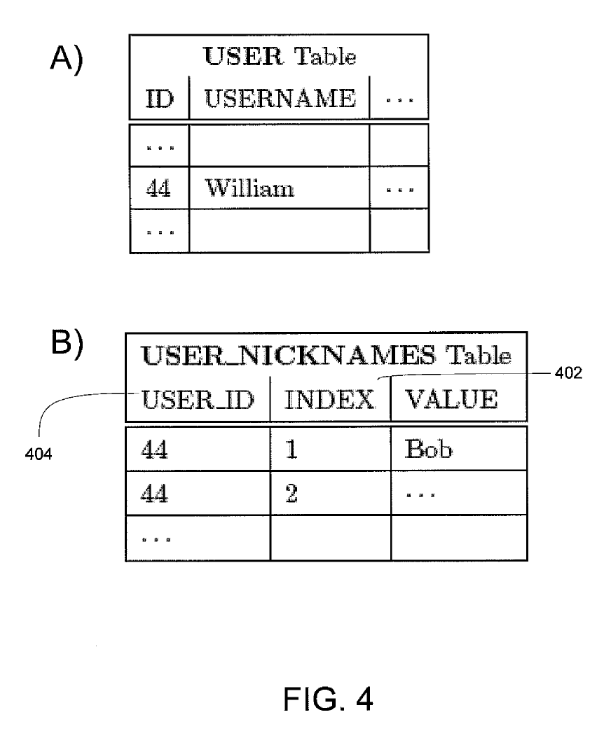

In addition to having simple attributes, an entity may also comprise a collection of values implemented as a complex attribute. For example, one user can have multiple nicknames, multiple secondary addresses, or multiple secondary nationalities. Complex attributes may be represented as a “collection” in the object environment and as a secondary table in the corresponding relational database. An example of a mapping between a collection (e.g., named “nicknames”) and a secondary table (e.g., named “USER_NICKNAMES”) is illustrated with reference to FIG. 4 and the following xml snippet:

<list name =“nicknames” table=”USER_NICKNAMES”>

| | |
|---|---|
| <key column=”USER_ID” /> | <- foreign key column |
| <list-index column=”INDEX” /> | <- relative index in the collection |

<element type=”string” column=”VALUE” /> <- column where the values are stored
</list>

The foregoing xml snippet maps the collection “nicknames” to the secondary table “USER_NICKNAMES” shown in FIG. 4B, by associating the column 402 (e.g., named “INDEX”) with indices for the different nicknames in the collection “nicknames.” The USER table shown in FIG. 4A is linked to the secondary table “USER_NICKNAMES” via the foreign key column 404 (e.g., named “USER_ID”). Thus, in this example, if in response to a request to access the nicknames of the user named “William,” the object-relational system would return a value of “Bob.”

Attributes may be generalized and referred to as a “path” of an entity. Paths may be defined recursively such that a first level of the path includes only the attributes of the entity. However, if any part of a path refers to another entity (e.g., if it is a foreign key in relational parlance or a reference (or a pointer) in object-oriented parlance), the path may also include the attributes of the referring entity. Accordingly, each entity has a list of paths that includes all the attributes of the entity. For example, the entity “com.example.entities.User” may have the following paths:

| Path | Type |
|---|---|
| username | java.lang.String |
| address | com.example.util.Address |
| nationality | com.example.entities.Nationality |
| nicknames | java.lang.String |

Paths have a type that is derived from the attribute type (e.g., the type for the path “nicknames” is “java.lang.String,” not “List<java.lang.String>). The attributes of a path are also paths for an entity. For example, the composite type “com.example.util.Address” has three attributes (street, city and zipcode). Thus, since “address is a path of the type “com.example.entities.User, the entity “com.example.entities.User” also includes the paths:

| Path | Type |
|---|---|
| address.street | java.lang.String |
| address.city | java.lang.String |
| address.zipcode | java.lang.String |

Hibernate (and other ORM technologies) provide “hybrid” tools to query data in a relational database (referred to as object query language or OQL) because SQL (the de facto standard query language for relational systems) does not map cleanly to the object system. For example, an SQL query for finding all users living in zip code 75025 may be as follows (in the relational environment):

select u.ID
from USER u
where u.ADD_ZIPCODE = 75025

However, this SQL query is not well formed in the object-oriented environment because the attribute “ADD_ZIPCODE” is not defined in the object-oriented environment. A proper OQL query corresponding to the SQL query above may be:

from com.example.entities.User
where equals (address.zipcode, 75025)

A statement in OQL, such as the one above, consists of two parts: the entity being searched for (e.g., “com.example.entities.User”) and the predicate (e.g., “address.zipcode=75025”) that specifies the search criteria. A predicate can be further broken down into various components, such as path (“address.zipcode”), operator (“equals”) and value (“75025”). A path is only applicable within the context of the reference entity. For example, the path “address.zipcode” in the foregoing example may not be applicable for the entity “com.example.entities.Country”

In another example of an OQL query, a list of users with a country of nationality specified as “USA” may be represented as:

from com.example.entities.User
where equals (nationality.country.name, “USA”).

### 3. Object-Relational System in a SaaS Environment

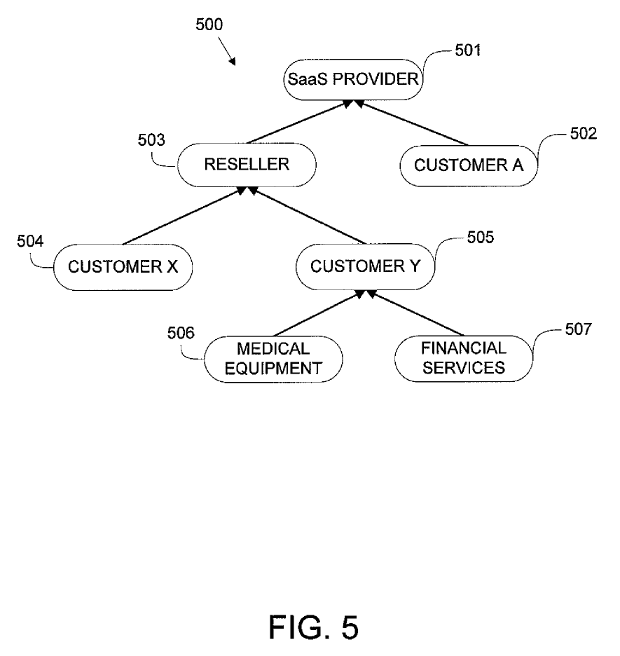

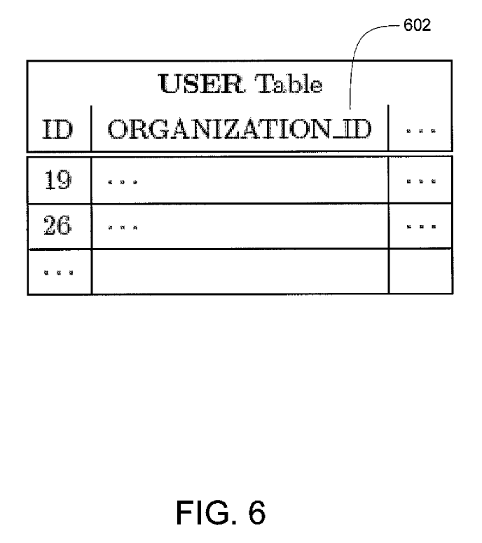

In some embodiments of the invention, every entity may be associated with an additional attribute that refers to an node in an organization tree 500 as shown in FIG. 5. For example, the entity “com.example.entities.User” associated with a USER table in a relational database (as illustrated in FIG. 6) may have an attribute “organization” that refers to a node in the tree (e.g., node 502 named “Customer A”). An exemplary xml snippet for mapping between the attribute “organization” defined in an object environment and a column in a relational database (e.g., column 602, named “ORGANIZATION_ID,” according to embodiments of the invention may be:

```
<class name=”com.example.entities.User” table=”USER”>
...
<many-to-one name =”organization”
    column=”ORGANIZATION_ID”
    class =”com.example.entities.Organization”/>
...
</class>
```

As should be appreciated from the foregoing discussion of ORM tools (e.g., Hibernate), the preceding mapping will enable an application written in an object-oriented language to access the corresponding table record(s) in an associated relational database. For example, an application may query the relational database to determine a list of users associated with one or more nodes of the organization tree 500.

The organization tree 500 may be a hierarchical data structure implemented in a SaaS environment that comprises a primary node (e.g., node 501) which represents a SaaS provider, and a plurality of secondary nodes which may represent, for example, different organizations (e.g., customers) or departments within an organization that have been provided access an enterprise server of the SaaS provider for some service (e.g., remote-access network authentication). Each of the secondary nodes may be considered a child node of a parent node to which it is directly linked (e.g., node 505 is a child node of parent node 503). It should be appreciated that some nodes in organization tree 500 may be both parent nodes and child nodes. For example, the node 505 is a child node of the parent node 503, and node 505 is also the parent node of the child nodes 506 and 507.

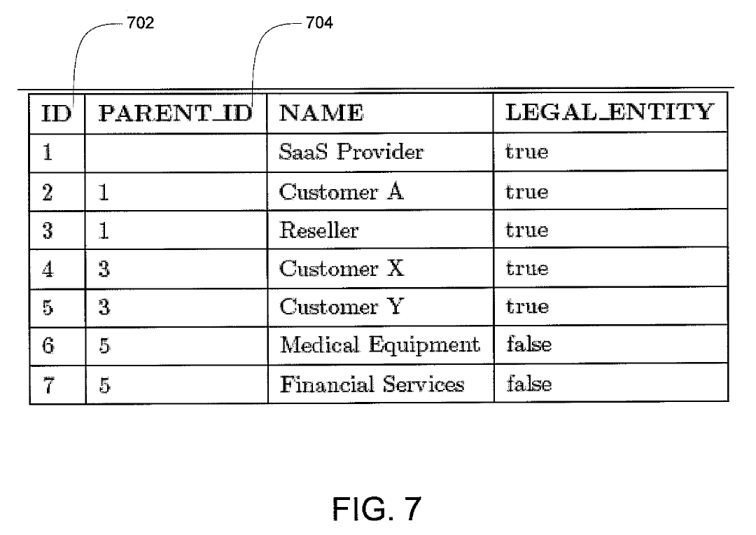

The hierarchical relationships (e.g., parent-child relationships) between nodes in organization tree 500 may be represented in a table of a relational database in an object-relational system as illustrated in FIG. 7. Each record (i.e., row) of the table of FIG. 7 represents a node in the organization tree 500, and is assigned a unique identifier (represented in column 702). The hierarchical relationships between the nodes in the organization tree 500 are represented via column 704 (e.g., named “PARENT_ID”), which refer to the parent node ID for each of the secondary nodes in the tree. Thus, it is possible to reconstruct the hierarchical relationships merely by examining the columns 702 and 704 of the table of FIG. 7.

In some embodiments of the invention, all processing (e.g., through queries from an application) in the object-relational system is associated with an organization context. Keeping track of organization context during processing is referred to herein as “visibility.” Visibility, in accordance with some embodiments of the invention, may be either “bottom-up” or “top-down.”

In top-down visibility, a result set (e.g., provided in response to a query from an application) is defined as the union of a subset of the set of entities (e.g., the subset “users”) that belong to the context node (i.e., the node having a context consonant with the query that was generated) and a subset of the set of entities that belong to each of the child nodes in a subtree rooted at the context node. For example, if a query is executed in the context of node 503, the result set will include a subset of the entities defined for node 503 (i.e., the context node), and a subset of the entities (e.g., the subset “users”) of each of the nodes in the subtree rooted at node 503 (i.e. nodes 504, 505, 506, and 507).

In bottom-up visibility, a result set is defined as the union of a subset of the set of entities that belong to the context node and a subset of the set of entities that belong to each node in the path between the context node and the primary node. For example, if a query is executed in the context of node 505, the result set may include a subset of the entities defined at node 505 (i.e., the context node) and each of node 505's parent (and grandparent) nodes (i.e., node 503 and node 501).

In accordance with embodiments of the invention, entities that are managed (e.g. users, computers) generally follow bottom-up visibility and entities that define how other entities are managed (e.g. configuration, service plans) generally follow top-down visibility.

The concepts of hierarchy and visibility, in accordance with embodiments of the invention, impart data partitioning within the object-relational system employed on an enterprise system of a SaaS provider. For example, whenever a business process is executed in the object-relational system, a projection of the data is presented to the system. The scope of the projection (i.e., which nodes on the organization tree 500 are involved) is dictated by the visibility type of the entity (bottom-up or top-down) that executed the business process.

Accordingly, associating queries with a context and using the concept of visibility enables isolation between customers in an SaaS environment. For example, entities that have “top down” visibility only affect the entities that are defined within their subtrees. That is, Customer Y (i.e., node 505) can define entity extensions that are valid only for nodes the context node (node 505) and the subtree of the context node (e.g., nodes 506 and 507). Furthermore, such entity extensions can only be referred to by rules executed with a context within the subtree where they are defined. In accordance with some embodiments, top-down visibility of entities allows providers (e.g., SaaS providers or Resellers) to define services (e.g., connectivity plans) and make them available to one or more bottom-up entities defined in the provider's subtree.

In some embodiments, extension attributes of an entity are defined by the set of “com.example.entities.Attributes” visible at the context node. For example, an instance of “com.example.entities.User” defined at the node 505 for Customer Y may have extension attributes defined by the subset of “com.example.entities.Attributes” visible at node 505 that includes instances of “com.example.entities.Attributes” defined at node 501 (SaaS Provider), node 503 (Reseller), and node 505 (Customer Y) (e.g., corresponding to the top-down visibility of “com.example.entities.Attributes”).

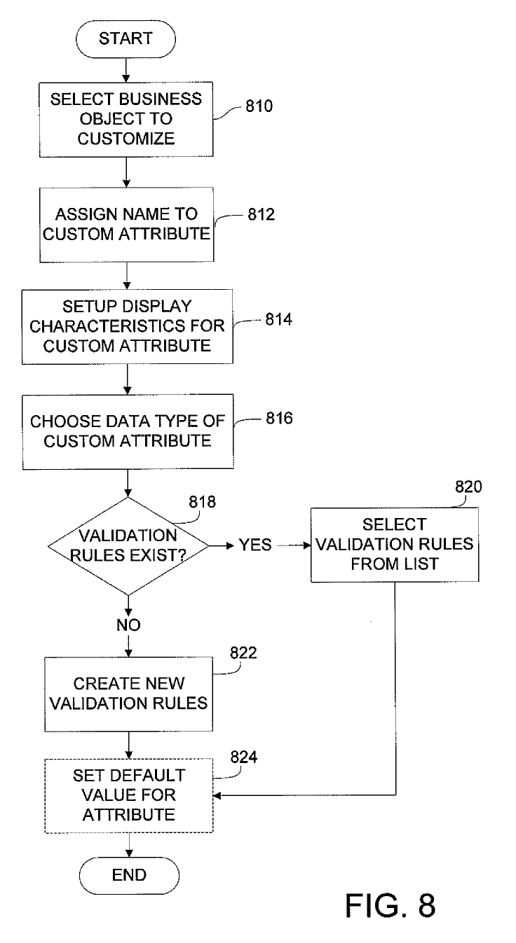

A process for creating an extension attribute, in accordance with some embodiments of the invention, is illustrated in FIG. 8. In act 810, a business object (e.g., “entities.User”) may be selected to add a custom attribute. For example, a user of an organization (e.g., a SaaS provider) may be presented with an interface that displays a list of available business objects to customize, and the user may select one of the available business objects. In act 812, a name (e.g., a path as described above) may be assigned to the new custom attribute, then in act 814, one or more display characteristics (e.g., localized display texts that would appear on User Interfaces for various customers in the SaaS environment) for the custom attribute may be set up.

In act 816, a data type for the custom attribute is selected. In some embodiments, the data type may be a single value, a list, a set, or a map, and the value may be selected from a fundamental data type (e.g., integer), structures or composite data type, or an enumeration. However, it should be appreciated that the data type of the custom attribute may be any suitable data type, as aspects of the invention are not limited in this respect.

In act 818, it may be determined if any validation rules for the new custom attribute exist. In accordance with some embodiments, validation rules may be a set of rules that values for the custom attribute must conform to in order to be considered valid (e.g., the value must be within a predefined range). If there are existing validation rules for the new custom attribute, they may be selected from a list of available validation rules in act 820. Otherwise, if validation rules do not exist for the new custom attribute, new validation rules may be created in act 822. Any number of validation rules may be defined in act 822, as aspects of the invention are not limited in this respect.

In act 824, a default value for the new attribute may be selected. The default value may be specific to an organization that is defining the attribute, and may, for example, be used in one or more default fields on a graphical user interface (GUI) presented to users of the organization.

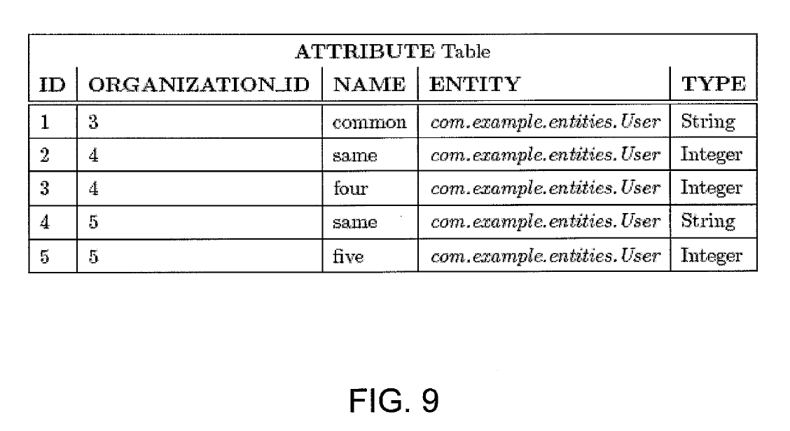

An exemplary scenario where instances of the entity “com.example.entities.Attribute” defined at different nodes of the organization tree 500 is shown in FIG. 9. If an entity of the type “com.example.entities.User” is defined at any one of node 505, node 506 or node 507, the entity may have the extension attributes:

| Name | Type |
|---|---|
| common | String |
| same | Integer |
| five | Integer |

Each of nodes 505, 506, and 507 have bottom-up visibility of node 503 and node 501, but nodes 505, 506, and 507 do not “see” either of nodes 504 or 502 (i.e., because they are in different branches of the organization tree 500). Thus, the extension attribute “common” (defined at node 503) has the type “String” according to the mapping shown in FIG. 9. Similarly, the extension attribute “same” (defined at node 505) has the type “Integer,” and the extension attribute “five” (also defined at node 505). has the type “Integer.”

In contrast, the same entity “com.example.entitites.User” (defined at node 504 for Customer X) also within organization tree 505 has the following extension attributes:

| Name | Type |
|---|---|
| common | String |
| same | String |
| four | Integer |

Again referring to the organization tree 500, the entities at node 504 only have bottom-up visibility of nodes 503 and 501 (i.e., not nodes, 502, 505, 506, and 507). Thus, according to the mapping shown in the table of FIG. 9, the extension attribute “common” has the type “String” (defined at node 503), the extension attribute “same” has the type “String” (defined at node 504), and the extension attribute “four” has the type “Integer” (also defined at node 504).

As discussed above, in some embodiments, the nodes in an organization tree may be customers in a SaaS environment, with the top (i.e., primary) node in the tree being associated with the SaaS provider. As should be readily appreciated from the foregoing discussion, a hierarchical system, in accordance with embodiments of the invention, employed with the concept of visibility, enables entities to be extended by two customers independent of each other. Accordingly, modifications made by one customer in the organization tree do not affect the functionality or performance of other customers in the organization tree.

Applicants have recognized and appreciated that the foregoing hierarchical object-relational system may be implemented in a SaaS environment to enable customers to generate a customized audit trail according to their own needs. For example, one customer may want to keep track of when users in their organization modify the user's password (e.g., for security purposes), whereas another customer may want to keep track of all of the modifications made by users with a particular billing code. Accordingly, some embodiments of the invention are directed to an audit trail system in which one or more customers in a SaaS environment may create a customized audit trail configuration for generating an audit trail.

In some embodiments, customers in an SaaS environment may designate the information to be captured in an audit trail using an object-relational model implemented on an enterprise system of the SaaS provider. In one implementation, the model may be called “AuditConfiguation,” and customers can instantiate instances of the model to begin capturing one or more audit trails whenever an attribute of an instance of an entity (as specified by the model) is modified. For example, a customer may configure the model to begin capturing an audit trail any time that a user of the customer's organization accesses the enterprise system of the SaaS provider and modifies the attribute “username” for their account.

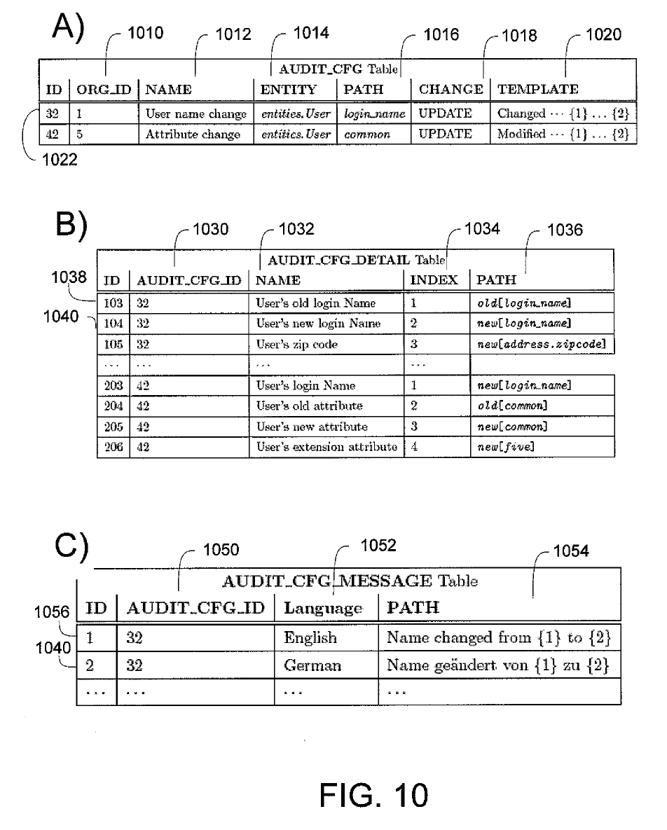

A table for storing information related to a data model for configuring an audit trail, in accordance with embodiments of the invention, is shown in FIG. 10A. Each of the columns in the table of FIG. 10A represents a customizable component of the model which specifies the criteria for generating an audit trail, and each of the records (i.e., rows) in the table of FIG. 10A represents an “audit” that may be triggered in response to a modification of a corresponding attribute.

The components of an audit used with the exemplary model shown in FIG. 10A includes a first column 1010 (named “ORG_ID”), which stores information to identify the organization (e.g., customer represented by a node in the organization tree 500) which created the audit. For example, in embodiments implemented in an SaaS environment, a SaaS provider may create an audit configured to track each time that a user in an organization changes their username (e.g., as illustrated in record 1022). The value in column 1010 identifies that this audit was created by the SaaS provider (e.g., node 501 in the organization tree 500). It should be appreciated from the foregoing discussion of visibility, that audits defined at the primary node of an organization tree are visible to all customers of the hierarchy. Thus, in some embodiments, an SaaS provider may define a standard set of audits that each of the customers may use to generate an audit trail. As the business needs of each customer changes, the customer may define additional audits, as described in more detail below.

A second column 1012 specifies the name of the audit as defined by the customer identified in column 1010. A third column 1014 identifies the entity used for the audit. For example, the audit defined in record 1022 is applicable to the entity “entities.User” because the audit is for tracking modifications in usernames. A fourth column 1016 identifies a path for an attribute of the entity specified in column 1014. For example, since the audit in record 1022 is for tracking changes in a user's login name, the path specified in the column 1016 is “login_name.”

The entity specified in column 1014 and the attribute path indicated in column 1016 may be used, in some embodiments, to determine when the audit defined in record 1022 is to be triggered. For example, the audit defined in record 1022 may be triggered any time that a user (as defined by the object “entities.User”) makes a modification to the attribute “login_name.” In some embodiments, if an attribute path is missing or unspecified, the audit may be triggered whenever an the entity instance is acted upon (i.e., whenever any attribute of the entity is modified), although aspects of the invention are not limited in this respect.

A fifth column 1018 identifies the type of modification that is to be captured by the audit. In some embodiments, the type of change may be defined as one of the following values: INSERT, UPDATE, DELETE or ALL corresponding to the actions of “create,” “modify,” “delete,” and “all.” Thus, the audit defined in record 1022 may be triggered whenever a user modifies their username (i.e., because the change type 1018 is “UPDATE”).

A sixth column 1020 defines a template string that is used for reporting of audit trail data corresponding to a particular audit. Customers (or an SaaS provider) may customize the template string for an audit in any way, so that the format of messages displayed in an audit trail report that is generated by triggering the audit meets the customer's specific needs. A template string, in accordance with embodiments of the invention, is comprised of template words and placeholders. For example, a template string for the audit defined in record 1022 may be defined as “Changed login name {1} to {2}.” By defining a template string that is used for each invocation of the audit, customers are presented with an audit trail report that is uniform and customizable to suit their business needs. Although the template words in a template string are constant across invocations of an audit, the values of the placeholders are determined each time that the audit is triggered.

In some embodiments, the values of the placeholders of a template string for an audit are captured by a model (e.g., named “AuditConfigurationDetail”) having components represented by the columns of a table shown in FIG. 10B. A first column 1030 indicates a reference to the corresponding audit in the audit configuration model (e.g., represented in the table of FIG. 10A). For example, column 1030 indicates that the entry in record 1038 of the AuditConfigurationDetail model is associated with the audit in record 1022 of the audit configuration model shown in FIG. 10A.

A second column 1032 indicates the name of the attribute for which a value is to be determined. For example, record 1038 is associated with a modification to a username, and is configured to determine the old login name of the user (i.e., the value of the username prior to the modification). A third column 1034 indicates which placeholder in the template string is associated with the particular record in the table of FIG. 10B. The example template string above includes three placeholders (i.e., labeled {0}, {1}, and {2}). Each of these placeholders may be associated with a particular record in the table of FIG. 10B. For example, the record 1038 is associated with the placeholder {1}, so that value of the placeholder for a user's old login name is inserted into the correct position of the template string. Similarly, each of the other placeholders in the template string (i.e., labeled {0} and {2}) may also be associated with a record in the table of FIG. 10B.

A fourth column 1036 maps to the value that should be inserted into the placeholder location specified in the column 1034. An attribute path in the column 1036, in accordance with embodiments of the invention, may be specified in at least two ways. In one implementation, if the path is prefixed with “old” (e.g., as in record 1038), the model captures information about the modified attribute prior to the modification taking place. However, if the path is prefixed with “new” (e.g., as in record 1040), the model captures information about the modified attribute after the modification has completed. Although the qualifiers “old” and “new” have been disclosed for use with one implementation, it should be appreciated that any method of designating pre- and post-modification qualifiers for an attribute path may also be used, as embodiments of the invention are not limited in this respect.

In some embodiments, the format of the audit trail messages (i.e., corresponding to the template strings 1020) may be internationalized and/or localized using a model that captures the message template string for one or more “nondefault” languages or locales. Internationalization of the audit trail information, enabling the audit trails to be read and analyzed in multiple languages provides additional flexibility for customers with a global presence (e.g., customers with a headquarters in France, data analysts in Spain, and clients in the United States may want to have the capability to read and analyze the audit trails in at least three different languages (French, Spanish, and English)).

A model in accordance with embodiments that support internationalization of message templates is illustrated in FIG. 10C. A first column 1050 references an audit in an audit configuration model associated with a particular record of the model (e.g., similar to the function of column 1030 in the model of FIG. 10B). A second column 1052 indicates a particular language or locale used to configure the message template. For example, record 1056 is configured to display a message template using English, whereas the record 1058 is configured to display the same message template using German. A third column 1054 indicates a translation of the message template into the language (or locale) specified in the column 1052.

In one implementation, the language that is used for displaying message templates in an audit trail may be determined based upon the location of the user that is accessing an enterprise server in a SaaS environment. The location of the user may be determined in any suitable way (e.g., via an internet protocol (IP) address, or stored information about the user), as aspects of the invention are not limited in this respect. For example, when a user at the headquarters of customer X in France wants to review an audit trail, the audit trail messages may be presented in French. However if a data analyst of customer X in Spain wants to review the same audit trail, the audit trail messages may be presented in Spanish.

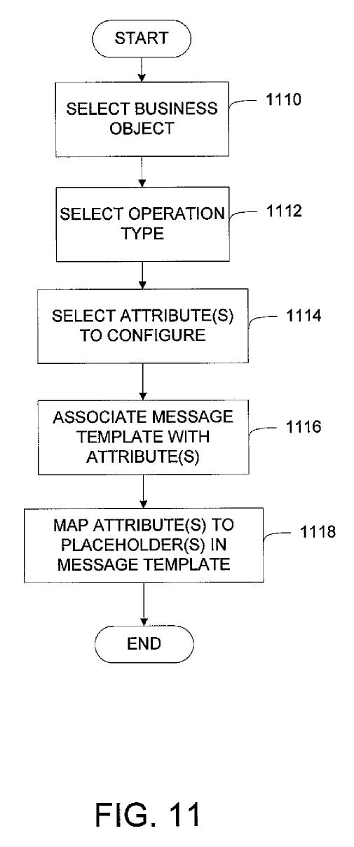

A generalized process for configuring an audit, in accordance with some embodiments of the invention, is illustrated in FIG. 11. In act 1110, a user of an organization (e.g., a customer or SaaS provider) selects a business object (e.g., the business object “User”) for which an audit configuration is to be defined. In act 1112, an operation type for the audit is selected. For example, is some embodiments, the operation type may be any one of ADD, UPDATE, DELETE, or ALL as described above. In act 1114, one or more object attributes are selected for configuration. In one exemplary implementation, the selected business object may be “User,” the selected operation type may be “UPDATE,” and the selected attribute may be “zipCode.”

In act 1116, a localized message template is associated with each attribute being tracked in the audit using the configuration information selected in acts 1110-1114. For example, in the exemplary implementation above, the localized message template may be “Zipcode changed from {0} to {1} for user {2},” in which the values in the placeholders {0}, {1}, and {2} will be determined each time that the audit is triggered. Then, in act 1118, the configuration information (i.e., selected in acts 1110-1114) is used to map each of the attributes to the placeholders in the localized message template.

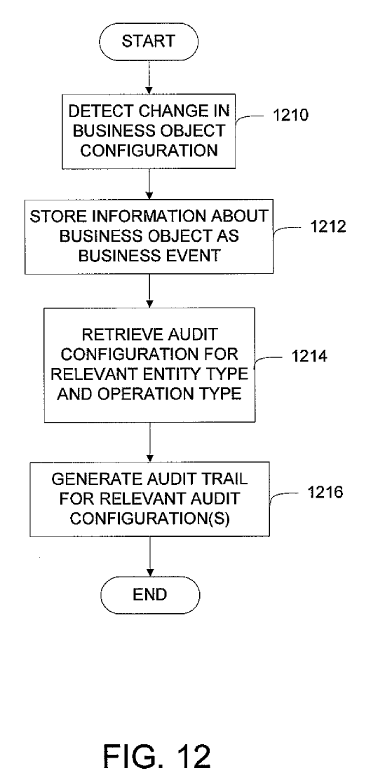

A generalized example of an audit process based on one or more audits configured to respond to actions on a business object (e.g., additions, deletions, or modifications) is shown in FIG. 12. In act 1210, a change in a business object configuration is detected. For example, an organization may have defined an audit to capture each time that a user in the organization changes the user's password. Thus, in one instance of act 1210, it may be determined that a user as modified the user's password, triggering the collection of information for an audit trail. in act 1212, information about the particular instance of a modification in the business object is stored as a business event.

In act 1214 the audit configuration for the relevant entity type and operation type combination (e.g., User+UPDATE) that is visible to the organization context is retrieved (e.g., for Customer Y in the organization tree 500, the visibility may include all audit configurations at node 505 and also at nodes 503 and 501. After retrieving the relevant audit configurations, an audit trail is generated for the particular instance of the business event respecting the configuration details in the audit. For example, event details for the particular instance may be recorded using a message template stored for the audit that was triggered in response to the action.

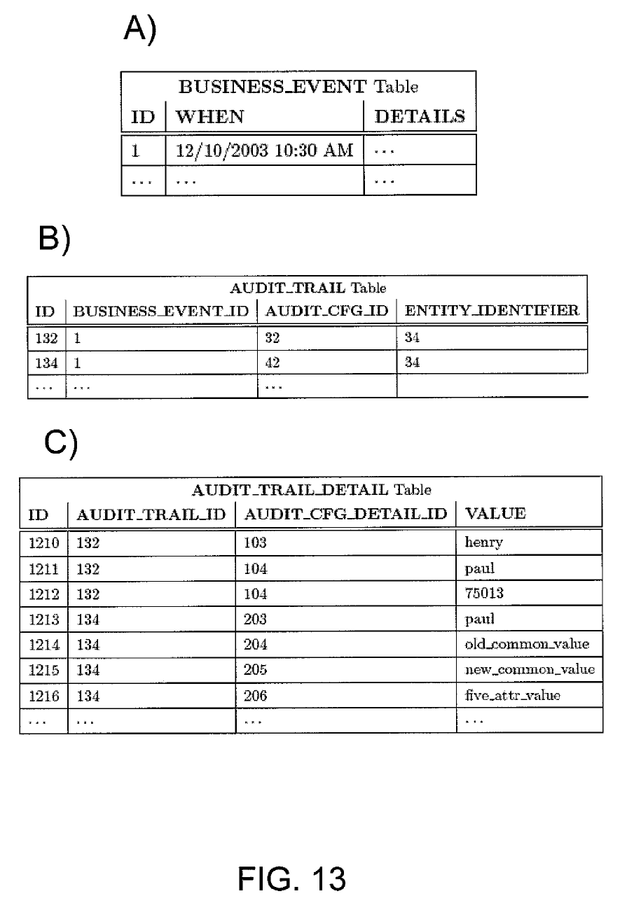

In some embodiments, audit trail information is collected using one or more of the tables shown in FIG. 13. A first model (e.g., named “BusinessEvent”) shown in FIG. 13A may be used to encapsulate the identity of a user or application that initiated a modification to the models shown in FIG. 10 (e.g., the audit configuration model shown in FIG. 10A). For example, a table named “BUSINESS EVENT” may capture the name of the business event, the time at which it was executed, who executed the event, etc. In one implementation, the BusinessEvent model may also capture some or all of the related changes that were executed in the transaction.

A second model (e.g., named “AuditTrail”) shown in FIG. 13B, may refer to the BusinessEvent model and may be configured to define all the audits (e.g., by their identifiers in the audit configuration model shown in FIG. 10A) that are associated with a particular business event in the BusinessEvent model. That is, the AuditTrail model may capture multiple audits triggered within a business event. In one implementation, each record in the AuditTrail model may also include an identifier for the entity object (e.g., “entities.User”) that is being audited.

In some embodiments, the AuditTrail model may be associated with one or more child models (e.g., a child model named, “AuditTrailDetail” shown in FIG. 13C) that link the information in the AuditTrail model shown in FIG. 13B to the information in the AuditConfigurationDetail model shown in FIG. 10B. That is, the AuditTrailDetail model may capture the values of the attributes that changed during the business event. For example, in one implementation, for each applicable audit defined for an audit trail, the AuditTrailDetail model may store the value of all of the paths in the Audit Configuration Detail model shown in FIG. 10B.

ORM tools (e.g., Hibernate) provide hooks to manage the life cycle of entities. A software developer can use these hooks to intercept control and inject instructions during the various stages of the life cycle: on-update, on-delete and on-insert of entity objects. For each of the life cycle events, the audit configurations may be examined, information may be extracted from the entity instance, and this information may be used to populate at least some of the audit trail tables. An exemplary implementation of managing a life-cycles of an entity “obj” of type “entity type” is illustrated with the following pseudocode snippet:

```
event = fetch the business event
org = organization for obj
configs = audit configuration entities defined for entity type visible at org
for each config in configs
    add a record to AUDIT TRAIL (event id, config id, obj id)
    details = details of the config
    foreach detail of details
        value = fetch the value from obj for the path specified in detail
        add a record to AUDIT TRAIL DETAIL (config id, detail id,
    value).
```

Although at least some of the models disclosed herein (e.g., the model of FIG. 9B) may be used for collecting data during the generation of an audit trail, as described above, one or more of the models disclosed herein may alternatively be used for servicing queries related to searching and/or analyzing an existing audit trail stored locally on a customer's network or on an enterprise system of a SaaS provider.

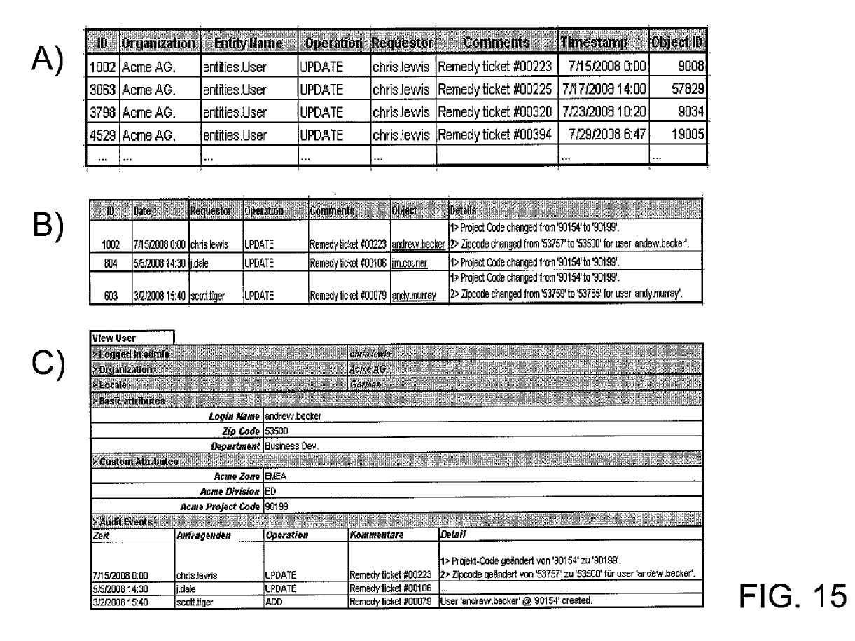

In accordance with an embodiment of the invention, an application may generate a query to retrieve information from an audit trail based for a particular business event. For example, an organization may want to determine all of the update events captured in an audit trail for the “User” business object that were requested by a user “chris.lewis” between Jul. 10, 2008 and Jul. 30, 2008. An exemplary output in response to a business-event query, in accordance, with some embodiments of the invention, is illustrated in FIG. 15A. As illustrated in FIG. 15A, an exemplary report based on a business-event query may use search criteria, such as those provided above (i.e., username, date range, etc.), to search an audit trail for a set of records that meets the search criteria. Although the output shown in FIG. 15A is in the form of a table, it should be appreciated that the output of search query related to a business event may be provided in any suitable form, as embodiments of the invention are not limited in this respect.

Another type of search query, in accordance with embodiments of the invention is a search query based on a captured object state. The table in FIG. 15B, shows an exemplary output for such a query based on an captured object state for an organization context which shows records in an audit trail where a user's project code was updated from “90154” to “90199.” As should be appreciated from the table in FIG. 15B, in some embodiments, the query is translated into the form of an template message, where the search terms are inserted as the placeholders in the template message. After creation of the “search” template message based on the search terms, any records in an audit trail having a field which matches the generated search template message are collected as shown in FIG. 15B, where it was found that three users had their project code changed from “90154” to “90199.” Queries for searching audit trails may have any suitable number of search terms and/or search logic (i.e., boolean terms, etc.), as aspects of embodiments of the invention are not limited in this respect.

Some embodiments of the invention are directed to a method of searching an audit trail to determine audit business events that happened for a specific instance of a business object. For example, an customer may want to show an audit trail for a specific instance of the business object “User.” An exemplary output in response to a query based on a specific instance of the business object “User” is shown in FIG. 15C.

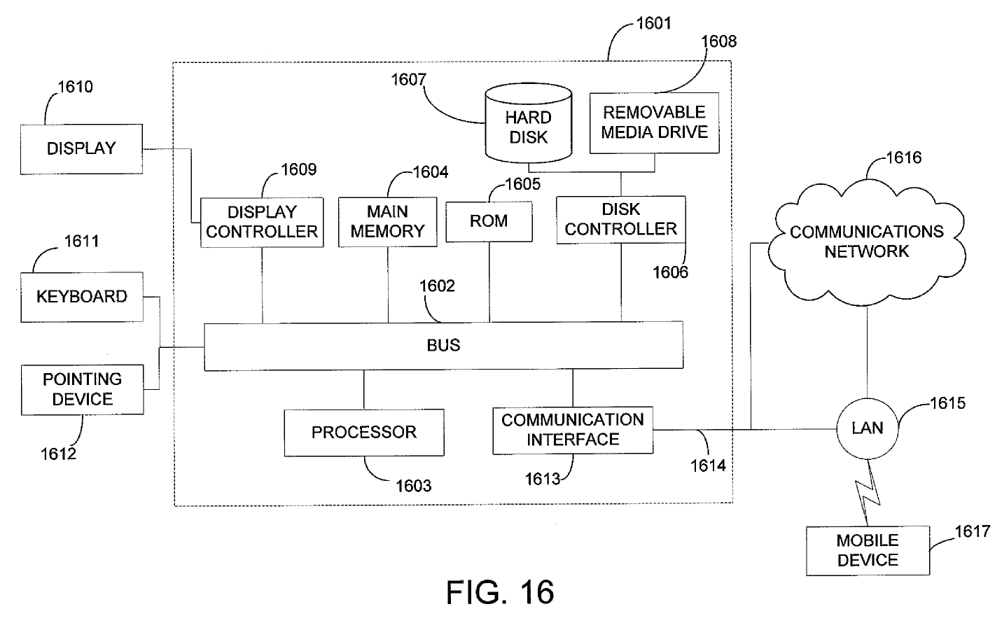

FIG. 16 illustrates a computer system 1601 upon which embodiments of the invention may be implemented. The computer system 1601 includes a bus 1602 or other communication mechanism for communicating information, and a processor 1603 coupled with the bus 1602 for processing the information. The computer system 1601 also includes a main memory 1604, such as a random access memory (RAM) or other dynamic storage device (e.g., dynamic RAM (DRAM), static RAM (SRAM), and synchronous DRAM (SDRAM), coupled to the bus 1602 for storing information and instructions to be executed by processor 1603. In addition, the main memory 1604 may be used for storing temporary variables or other intermediate information during the execution of instructions by the processor 1603. The computer system 1601 further includes a read only memory (ROM) 1605 or other static storage device (e.g., programmable ROM (PROM), erasable PROM (EPROM), and electrically erasable PROM (EEPROM) coupled to the bus 1602 for storing static information and instructions for the processor 1603.

The computer system 1601 also includes a disk controller 1606 coupled to the bus 1602 to control one or more storage devices for storing information and instructions, such as a magnetic hard disk 1607, a removable media drive 1608 (e.g., floppy disk drive, read-only compact disc drive, read/write compact disc drive, compact disc jukebox, tape drive, and removable magneto-optical drive). The storage devices may be added to the computer system 1601 using an appropriate device interface (e.g., a small computer system interface (SCSI), integrated device electronics (IDE), enhanced-IDE (E-IDE), direct memory access (DMA), or ultra-DMA.

The computer system 1601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1601 may also include a display controller 1609 coupled to the bus 1602 to control a display 1610, such as a cathode ray tube (CRT) or liquid crystal display (LCD), for displaying information to a computer user. The computer system includes input devices, such as a keyboard 1611 and a pointing device 1612, for interacting with a computer user and providing information to the processor 1603. The pointing device 1612, for example, may be a mouse, a trackball, or a pointing stick for communicating direction information and command selections to the processor 1603 and for controlling cursor movement on the display 1610. In addition, a printer may provide printed listings of data stored and/or generated by the computer system 1601.

The computer system 1601 performs a portion or all of the processing steps of embodiments of the invention in response to the processor 1603 executing one or more sequences of one or more instructions contained in a memory, such as the main memory 1604. Such instructions may be read into the main memory 1604 from another computer readable medium, such as a hard disk 1607 or a removable media drive 1608. The hard disk 1607 may contain one or more datastores and data files. Datastore contents and data files may be encrypted to improve security. One or more processors in a multi-processing arrangement may also be employed to execute the one or more sequences of instructions contained in main memory 1604. In alternative embodiments, hard-wired circuitry may be used in place of or in combination with software instructions. Thus, embodiments are not limited to any specific combination of hardware circuitry and software.

As stated above, the computer system 1601 includes at least one computer readable medium or memory for holding instructions programmed according embodiments of the invention and for containing data structures, tables, records, or other data described herein. Non-limiting examples of computer readable media include hard disks, floppy disks, tape, magneto-optical disks, PROMs (EPROM, EEPROM, flash EPROM), DRAM SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read instructions.

Stored on any one or on a combination of computer readable media, embodiments of the present invention include software for controlling the computer system 1601, for driving a device or devices for implementing the invention, and for enabling the computer system 1601 to interact with a human user. Such software may include, but is not limited to, device drivers, operating systems, development tools, and applications software. Such computer readable media further comprises a computer program product for performing all or a portion (if processing is distributed) of the processing performed in implementing embodiments of the invention.

Components of the computer system 1601 which interpret one or more sequences of instructions may be any interpretable or executable code component including, but not limited to, scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1603 for execution. A computer readable medium may take many forms including, but not limited to, non-volatile media, volatile media, and transmission media. Non-limiting examples of non-volatile media include optical, magnetic disks, and magneto-optical disks, such as hard disk 1607 or removable media drive 1608. Non-limiting examples of volatile media include dynamic memory, such as main memory 1604. Non-limiting examples of transmission media include coaxial cables, copper wire, and fiber optics, including the wires that make up the bus 1602. Transmission media may also take the form of acoustic or light waves, such as those generated during radio wave and infrared data communications.

Various forms of computer readable media may be involved in carrying out one or more sequences of one or more instructions to processor 1603 for execution. For example, the instructions may initially be carried on a magnetic disk of a remote computer. The remote computer may load the instructions for implementing all or a portion of the present invention remotely into dynamic memory and send the instructions over a telephone line using a modem. A modem local to the computer system 1601 may receive the data on the telephone line and use an infrared transmitter to convert the data to an infrared signal. An infrared detector coupled to the bus 1602 may receive the data carried in the infrared signal and place the data on the bus 1602. The bus 1602 carries the data to the main memory 1604, from which the processor 1603 retrieves and executes the instructions. The instructions received by the main memory 1604 may optionally be stored on storage device 1607 or 1608 either before or after execution by processor 1603.

The computer system 1601 also includes a communication interface 1613 coupled to the bus 1602. The communication interface 1613 provides a two-way data communication coupling to a network link 1614 that is connected to, for example, a local area network (LAN) 1615, or to another communications network 1616, such as the Internet. For example, the communication interface 1613 may be a network interface card to attach to any packet switched LAN. As another example, the communication interface 1613 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1613 sends and receives electrical, electromagnetic, or optical signals that carry digital data streams representing various types of information.

The network link 1614 typically provides data communications through one or more networks to other data devices. For example, the network link 1614 may provide a connection to another computer through a local network 1615 (e.g., a LAN) or through equipment operated by a network service provider, which provides communication services through a communications network 1616. The local network 1614 and the communications network 1616 use, for example, electrical, electromagnetic, or optical signals that carry digital data streams, and the associated physical layer (e.g., CAT 5 cable, coaxial cable, optical fiber, etc.). The signals through the various networks and the signals on the network link 1614 and through the communication interface 1613, which carry the digital data to and from the computer system 1601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase, and/or frequency shift keyed signals that are propagated over a conductive media, or transmitted as electromagnetic waves through a propagation medium. Thus, the digital data may be sent as unmodulated baseband data through a “wired’ communication channel and/or sent within a predetermined frequency band, different than the baseband, by modulating a carrier wave. The computer system 1601 may transmit and receive data, including program code, through the network(s) 1615 and 1616, the network link 1614, and the communication interface 1613. Moreover, the network link 1614 may provide a connection through a KAN 1615 to a mobile device 1617, such as a personal digital assistant (PDA), laptop computer, or cellular telephone.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of enabling at least one first customer in a software-as-a-service (SaaS) environment to create an audit trail, the method comprising acts of:
(A) associating the at least one first customer with a first node of a hierarchical data structure;
(B) enabling the at least one first customer to define an audit configuration at the first node; and
(C) creating the audit trail based at least in part on the audit configuration.

2. The method of claim 1, further comprising an act of:
(D) associating at least one second customer with a second node of the hierarchical data structure, wherein the audit configuration does not affect the functionality of the at least one second customer;

3. The method of claim 1, wherein the act (C) is performed in response to detecting an action related to the audit configuration, and wherein the audit trail comprises at least one template defined in the audit configuration, the at least one template comprising at least one placeholder.

4. The method of claim 3, wherein the act (C) further comprises determining a value for that at least one placeholder based at least in part on the action.

5. The method of claim 1, further comprising acts of:
(D) receiving a request to view at least a portion of the audit trail;
(E) determining a locale associated with the request; and
(F) displaying the audit trail in a language consistent with the locale.

6. The method of claim 1, wherein the act (B) comprises presenting to the at least one first customer, a user interface for customizing at least one rule for creating the audit trail.

7. A computer system for providing at least one data management service to a plurality of customers in a software-as-a-service (SaaS) environment, the computer system comprising:
at least one storage device; and
a processor programmed to store on the at least one storage device, a hierarchical data structure comprising a primary node and a plurality of secondary nodes, wherein the primary node is associated with a provider of the SaaS environment and each of the plurality of secondary nodes is associated with at least one of the plurality of customers, wherein the hierarchical data structure insulates a first customer of the plurality of customers from a change made to the computer system by a second customer of the plurality of customers.

8. The computer system of claim 7, wherein the hierarchical data structure is implemented on the at least one storage device as a portion of an object-relational data system.

9. The computer system of claim 7, wherein the change made to the computer system comprises defining an audit configuration for a business object at the secondary node associated with the second customer.

10. The computer system of claim 9, wherein the processor is further programmed to create an audit trail for the second customer based at least in part on the audit configuration.

11. The computer system of claim 7, wherein the processor is further programmed to enable the at least one of the plurality of customers to define context information for a set of audit information.

12. The computer system of claim 11, wherein the processor is further programmed to generate at least one audit trail based at least in part on the set of audit information.

13. The computer system of claim 12, wherein the processor is further programmed to collect the context information from at least one relational database stored on the at least one storage device in response to detecting the change to the computer system.

14. A method of defining an audit configuration for a customer in a software-as-a-service (SaaS) environment, the method comprising acts of:
(A) determining at least one parameter for the configuration, the at least one parameter including at least one attribute of a business object; and
(B) associating the at least one attribute with a message template, wherein the message template comprises at least one placeholder.

15. The method of claim 14, further comprising an act of:
(C) associating the audit configuration with a first node in a hierarchical data structure, and wherein the audit configuration is only defined for nodes in the hierarchical data structure at or below the first node.

16. At least one computer-readable medium encoded with a series of instructions that when executed on a computer in a software-as-a-service (SaaS) environment comprising a service provider and at least one customer, perform a method comprising acts of:
(A) associating the at least one first customer with a first node of a hierarchical data structure;
(B) enabling the at least one first customer to define an audit configuration at the first node; and
(C) creating the audit trail based at least in part on the audit configuration.

17. The at least one computer-readable medium of claim 16, wherein the method further comprises an act of:
(D) associating at least one second customer with a second node of the hierarchical data structure, wherein the audit configuration does not affect the functionality of the at least one second customer;

18. The at least one computer-readable medium of claim 16, wherein the act (C) is performed in response to detecting an action related to the audit configuration, and wherein the audit trail comprises at least one template defined in the audit configuration, the at least one template comprising at least one placeholder.

19. The at least one computer readable medium of claim 18, wherein the act (C) further comprises determining a value for that at least one placeholder based at least in part on the action.

20. A method of maintaining isolation between a first customer and a second customer in a software-as-a-service (SaaS) environment, the method comprising acts of:
(A) associating the first customer with a first node in a hierarchical data structure comprising a primary node and a plurality of secondary nodes coupled to the primary node to form a tree-like structure; and
(B) associating the second customer with a second node in the hierarchical data structure, wherein the second node is not in a path connecting the first node and the primary node.

21. The method of claim 17, further comprising an act of:
(C) presenting the second customer with a user interface to define an audit configuration associated with the second node, wherein defining the audit configuration does not affect the functionality or performance of the first customer.
